(19) United States
(12) Patent Application Publication
(10) Pub. No.: US 2025/0242266 A1
(43) Pub. Date: Jul. 31, 2025

(54) CONTROLLER APPARATUS, INFORMATION PROCESSING SYSTEM, CONTROLLER APPARATUS CONTROL METHOD, AND PROGRAM

(71) Applicant: Sony Interactive Entertainment Inc., Tokyo (JP)

(72) Inventors: Hitoshi Nakamura, Tokyo (JP); Yumi Ueda, Chiba (JP); Toshiyuki Ando, Tokyo (JP)

(73) Assignee: Sony Interactive Entertainment Inc., Tokyo (JP)

(21) Appl. No.: 18/843,516

(22) PCT Filed: Mar. 24, 2022
(86) PCT No.: PCT/JP2022/014191

§ 371 Date: Sep. 3, 2024

(51) Int. Cl. A63F 13/71; A63F 13/24; A63F 13/25; A63F 13/73

(52) U.S. Cl. CPC A63F 13/71; A63F 13/24; A63F 13/25; A63F 13/73

(57) ABSTRACT

A controller apparatus that is connected to an information processing apparatus in a communicable manner includes a main body that is elastically deformable. The controller apparatus detects a user operation performed on the main body, and outputs information indicating the detected operation to the information processing apparatus. In addition, the outputted information is used in an authentication process of controlling a lock state of the controller apparatus or the information processing apparatus.

### TECHNICAL FIELD

The present invention relates to a controller apparatus, an information processing system, a controller apparatus control method, and a program.

### BACKGROUND ART

In conventional techniques, controllers for use in games and the like typically include such materials as plastics which are relatively elastically undeformable.

Meanwhile, in order to enrich user experiences in games and the like, a technology of presenting tactile experiences including vibrations and inner forces has come into wide use in recent years.

### [Summary] [Technical Problems]

In order to provide a controller apparatus for enriching tactile experiences under the above-mentioned present circumstances, using elastically deformable materials to form main bodies of controller apparatuses is under study.

However, in a case where the main body of a controller apparatus includes such an elastically deformable material, a method for controlling a lock state of the controller apparatus itself (an inoperable state when a user has not been authenticated) or a lock state of an information processing apparatus or the like that is operated through the controller apparatus is not taken into consideration in current circumstances.

The present invention has been made in view of the above-mentioned circumstances, and one object thereof is to provide a controller apparatus which has a main body including an elastically deformable material and in which a lock state of an apparatus is taken into consideration, an information processing system including the controller apparatus, a control method for the controller apparatus, and a program.

### Solution to Problems

According to one aspect of the present invention for solving the above-mentioned conventional problems, a controller apparatus includes a main body that is elastically deformable, a detection section that detects a user operation performed on the main body, and an output section that outputs information indicating an operation detected by the detection section to the information processing apparatus. The information outputted by the output section is used in an authentication process of controlling a lock state of the controller apparatus or the information processing apparatus.

### Advantageous Effect of Invention

The present invention provides a controller apparatus in which a lock state of an apparatus is taken into consideration, an information processing system including the controller apparatus, a control method for the controller apparatus, and a program.

### BRIEF DESCRIPTION OF DRAWINGS

FIG. 1 is a schematic diagram depicting an example of a controller apparatus according to an embodiment of the present invention.

FIG. 2 is a schematic perspective view of an example of a sensor in the example of the controller apparatus according to the embodiment of the present invention.

FIG. 3 is a schematic block diagram depicting an example of a circuit section in the controller apparatus according to the embodiment of the present invention.

FIG. 4 is a functional block diagram depicting an example of a control section in the controller apparatus according to the embodiment of the present invention.

FIG. 5 is an explanatory diagram depicting a modification example of the controller apparatus according to the embodiment of the present invention.

FIG. 6 is a flowchart of an example of an authentication process that is performed by the controller apparatus according to the embodiment of the present invention.

### DESCRIPTION OF EMBODIMENT

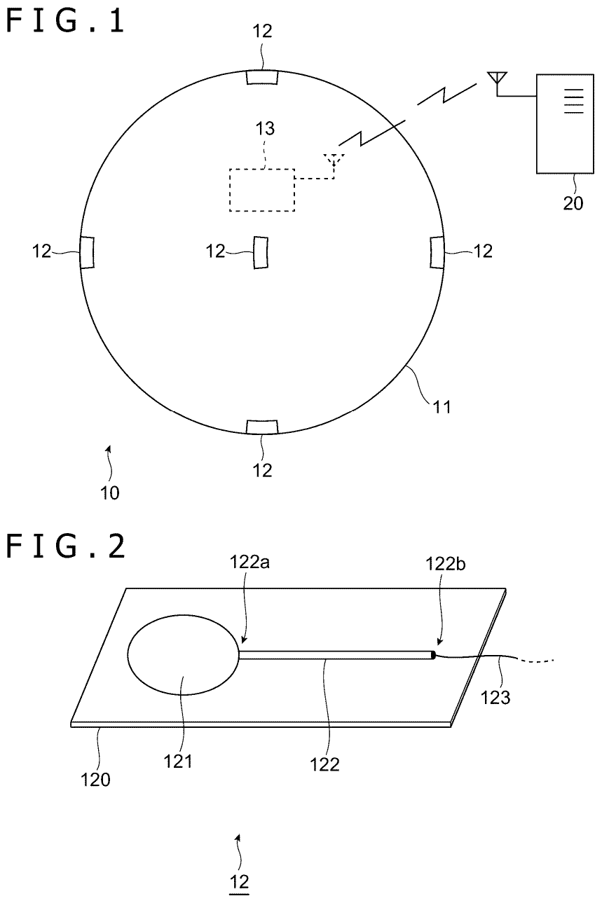

Hereinafter, an embodiment of the present invention will be explained with reference to the drawings. A controller apparatus 10 according to one example of the embodiment of the present invention includes a controller main body 11, electrostatic capacitance sensors 12 disposed on a surface of the controller main body 11 or around the surface (a position that is inside the controller main body 11 and is within a predetermined distance from the surface of the controller main body 11), and a circuit section 13, as depicted in FIG. 1. The controller apparatus 10 is wirelessly or wiredly connected to an information processing apparatus 20 in a communicable manner.

The controller main body 11 includes an elastically deformable material that is, for example, a polymer gel raw material such as a silicon-based polymer gel raw material or an urethane-based polymer gel raw material, or various kinds of elastomer raw materials such as a polystyrene-based elastomer, an olefin-based elastomer, a polyvinyl chloride-based elastomer, a polyurethane-based elastomer, a polyester-based elastomer, or a polyamide-based elastomer, for example. Further, in a certain example of the present embodiment, it is also preferable that the controller main body 11 include a light transmitting material.

The controller main body 11 has a predetermined shape such as a sphere or a box, for example, under a condition where no external force is exerted on the controller main body 11. When receiving an external force from a user finger or the like, the controller main body 11 elastically deforms according to the external force. In addition, at least one electrostatic capacitance sensor 12 is disposed on a surface of the controller main body 11 or around the surface. Moreover, the circuit section 13 is disposed inside the controller main body 11.

Each of the electrostatic capacitance sensors 12 according to the example of the present embodiment includes a base section 120, an electrode 121, a lead section 122, and a wiring section 123, as depicted in FIG. 2. Here, the base section 120 is a thin film-like member including an insulating material (e.g., an organosilicon compound which has an insulation property) that has elasticity. The electrode 121 and the lead section 122 are formed on the base section 120. At this time, the base section 120 may be integrated with the main body 11.

The electrode 121 including a conductive material having elasticity is disposed on the base section 120. The electrode 121 is formed into a predetermined shape having a predetermined area. For example, a conductive ink material or the like is used as the conductive material for forming the electrode 121. Here, the predetermined shape of the electrode 121 may be a circular shape, a rectangular shape (which may be an annular shape formed of an outer peripheral portion only), a coil shape, or the like.

The lead section 122 has an end 122a that is electrically connected to the electrode 121, and is formed, on the base section 120, into a linear shape having a predetermined width with use of an elastic conductive material. For example, a conductive ink material or the like can also be used as the conductive material for forming the lead section 122, as with the electrode 121.

The wiring section 123 has one end electrically connected to an end 122b which is opposite to the end 122a of the lead section 122, the end 122a being connected to the electrode 121, and has the other end connected to the circuit section 13. The wiring section 123 is disposed in such a manner as not to be in electric contact with the wiring sections 123 of the other electrostatic capacitance sensors 12 disposed on the surface of the controller main body 11 or around the surface.

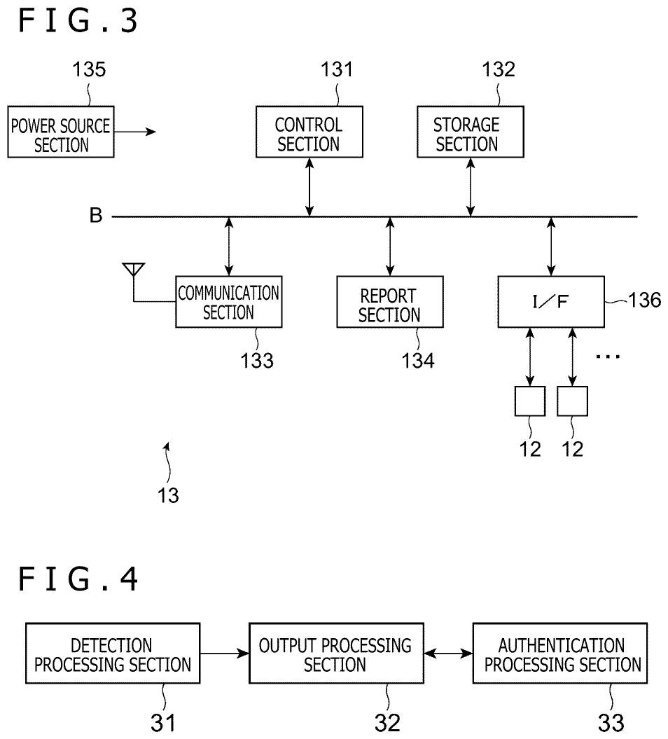

The circuit section 13 is disposed in the center portion (a position separated as far as possible from the surface) of the controller main body 11 of the controller apparatus 10. The circuit section 13 includes a control section 131, a storage section 132, a communication section 133, a report section 134, a power source section 135, and an interface section (I/F) 136, for example, as depicted in FIG. 3.

The control section 131 is connected to the storage section 132, the communication section 133, and the report section 134 via a bus B in a data exchangeable manner. The control section 131 is a program control device, and operates according to a program stored in the storage section 132. In an example of the present embodiment, the control section 131 detects a user operation performed on the controller main body 11, and transmits and outputs information indicating the detected operation to the information processing apparatus 20. In addition, when a predetermined condition is satisfied, the control section 131 controls a lock state (sets the lock state, or releases the lock state) of the controller apparatus 10 itself or the information processing apparatus 20 until a predetermined authentication operation (an authentication-related predetermined operation) is performed. Operations of the control section 131 will be explained later.

It is to be noted that a lock state herein refers to a state before authentication is performed. For example, if the information processing apparatus 20 is set to a lock state, processes that can be executed in accordance with a user command are limited to the authentication process and some of processes. In addition, when a lock state of the information processing apparatus 20 is released, the restriction on the executable processes including processes for starting and executing an application program (e.g., a game) is relaxed.

In addition, during a lock state of the controller apparatus 10 itself, control is performed to stop transmission, to the information processing apparatus 20, of information indicating the details of an operation accepted by the controller apparatus 10. In this lock state, the controller apparatus 10 performs control to stop transmitting the information to the information processing apparatus 20, until the controller apparatus 10 accepts a predetermined authentication operation for releasing the lock state of the controller apparatus 10 itself. Specifically, in this example, the controller apparatus 10 transmits information indicating the details of operations performed when the lock state is released, to the information processing apparatus 20.

The storage section 132 is a memory device, for example, and stores a program that is executed by the control section 131. The program may be a program that is provided in a state of being stored in a computer readable and non-temporal recording medium and is copied and stored in the storage section 132. Further, the storage section 132 also serves as a work memory of the control section 131.

The communication section 133 is a wireless local area network (LAN) network interface, Bluetooth (registered trademark), or the like and wirelessly exchanges data with the information processing apparatus 20 in accordance with a command inputted from the control section 131. Further, the communication section 133 outputs data received from the outside, to the control section 131.

The report section 134 is under control of the control section 131, and presents light, sounds, or vibrations. In one example, the report section 134 is equipped with a voice coil motor (VCM), and presents vibrations in accordance with a command inputted from the control section 131. In a case where a report on the circumstance is not required, the report section 134 is not necessarily required.

The power source section 135 has an internal battery (which may be a rechargeable secondary battery), and supplies power to the sections in the circuit section 13. The battery may be charged with power wirelessly fed in accordance with, for example, the Qi standard. The interface section 136 is connected to the electrostatic capacitance sensors 12, and outputs information indicating detection results obtained by the respective electrostatic capacitance sensors 12 to the control section 131.

Next, an explanation will be given regarding an operation example of the control section 131 according to the present embodiment. In one example of the present embodiment, the control section 131 functionally includes a detection processing section 31, an output processing section 32, and an authentication processing section 33, as depicted in FIG. 4.

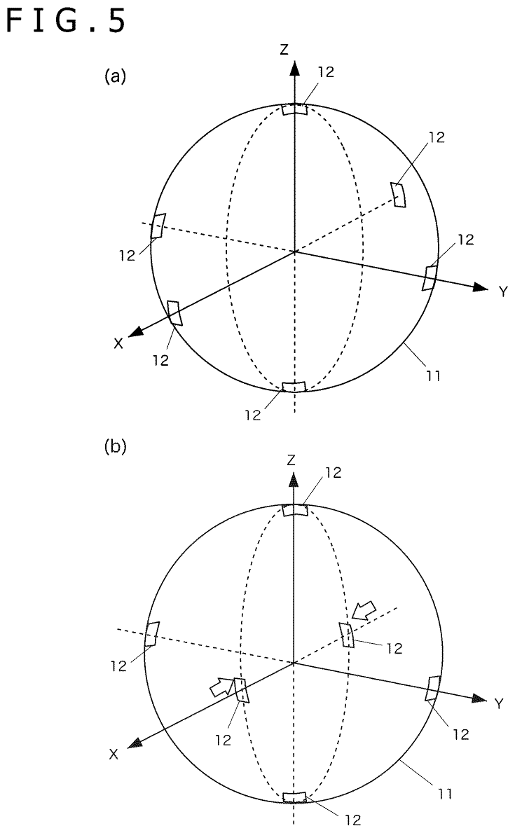

The detection processing section 31 repeatedly detects a user operation performed on the controller main body at every predetermined timing (e.g., 1/60 second). Specifically, the detection processing section 31 detects a user operation performed on the controller main body 11, which is elastic deformation of the controller main body 11 or the like, on the basis of detection results obtained by a plurality of the electrostatic capacitance sensors 12 disposed on the surface of the controller main body 11 or around the surface. For example, an XYZ orthogonal coordinate system the origin of which is set at the center of the controller main body 11 that has a spherical shape in a natural state where no external force is applied is virtually set, as depicted in FIG. 5(a). Further, it is assumed that electrostatic capacitance sensors 12 are disposed at six points in an X axis direction, a Y axis direction, and a Z axis direction on the surface of the controller main body 11. At this time, if two electrostatic capacitance sensors 12 in the X axis direction detect that the electrostatic capacitance sensors 12 are pressed by a user finger, it can be determined that the controller main body 11 is in a flat state extending in the Y axis direction and the Z axis direction, as depicted in FIG. 5(b). In addition, the flatness can be estimated from pressing forces detected by the two electrostatic capacitance sensors 12 in the X axis direction.

In the manner described above, for example, the detection processing section 31 estimates the state of the controller main body 11, from among a plurality of states including—a state where no operation is performed on the controller main body 11 (for example, none of the electrostatic capacitance sensors 12 detects a pressing force, or detects approach of a finger or a hand),—a state where the controller main body 11 is held in a hand (for example, two or more adjacent electrostatic capacitance sensors 12 detect approach of a finger or a hand while at least one of the remaining electrostatic capacitance sensors detects a pressing force),—a state where the controller main body 11 is deformed into a flat shape by being pressed to one direction (for example, two electrostatic capacitance sensors in any one of the axis directions each detect a pressing force equal to or larger than a predetermined force),—a state where the controller main body 11 is gripped (for example, five or more electrostatic capacitance sensors 12 detect pressing forces),—a state where the controller main body 11 is picked up (for example, one of the electrostatic capacitance sensors 12 detects a pressing force),—a state where the controller main body 11 is touched (for example, one or more electrostatic capacitance sensors 12 detect approach of a finger or a hand, and none of the electrostatic capacitance sensors detects a pressing force larger than a predetermined threshold), and—a state where the controller main body 11 is stroked (for example, a plurality of the electrostatic capacitance sensors 12 alternately detect approach of a finger or a hand), . . . , and detects which type of operation is performed.

Each time the detection processing section 31 detects an operation, the output processing section 32 outputs information indicating the details of the detected operation (which type of operation has been performed) to the authentication processing section 33 or the information processing apparatus 20. In one example of the present embodiment, the output processing section 32 uses an undepicted timer or the like to count an elapsed time from time when the detection processing section 31 detects the last operation other than the state where “no operation is performed,” and, when the elapsed time reaches a predetermined time, a lock state of the controller apparatus 10 is set.

During the lock state, when receiving, from the detection processing section 31, an input of information indicating the details of an operation detected by the detection processing section 31, the output processing section 32 outputs the information to the authentication processing section 33 without transmitting the information to the information processing apparatus 20.

In addition, during the lock state, when receiving, from the authentication processing section 33, an input of a command to release the lock state, the output processing section 32 releases the lock state. Then, when receiving an input of information indicating the details of an operation detected by the detection processing section 31 within a predetermined time period (e.g., within one minute), the output processing section 32 transmits the information to the information processing apparatus 20, and returns to the process of using the undepicted timer to count time elapsed from output of the last information indicating the details of a detected operation by the detection processing section 31.

In addition, if no input of information indicating the details of a detected operation is received from the detection processing section 31 within the predetermined time period after the lock state is released, the output processing section 32 may perform control to restore the lock state.

The authentication processing section 33 determines whether or not a predetermined authentication operation has been performed. Further, when determining that a predetermined authentication operation has been performed, the authentication processing section 33 releases a lock state of the controller apparatus 10 or the information processing apparatus 20 that is in the predetermined lock state.

A predetermined authentication operation to be determined by the authentication processing section 33 in the present embodiment may be a predetermined series of operations including at least one operation that is detectable by the detection processing section 31 (an operation pattern for authentication, which will hereinafter simply be referred to as an operation pattern). For example, the predetermined authentication operation may be defined by a permutation of the following three operations.
(Operation 1) pressing the controller main body 11 in any one of the axis directions (referred to as a first axis direction) and deforming the controller main body 11 into a flat state,
(Operation 2) pressing the controller main body 11 in an axis direction (referred to as a second axis direction) orthogonal to the first axis direction and deforming the controller main body 11 into a flat state, and
(Operation 3) pressing the controller main body 11 in an axis direction orthogonal to the second axis direction and deforming the controller main body 11 into a flat state.

The above operation pattern of the authentication operations is one example, and the operation pattern does not necessarily include only pressing operations (that is, operations involving elastic deformation). The operation pattern may include at least one pressing operation (operation involving elastic deformation), or may include no pressing operation. Moreover, not only one operation pattern but a plurality of operation patterns may be defined.

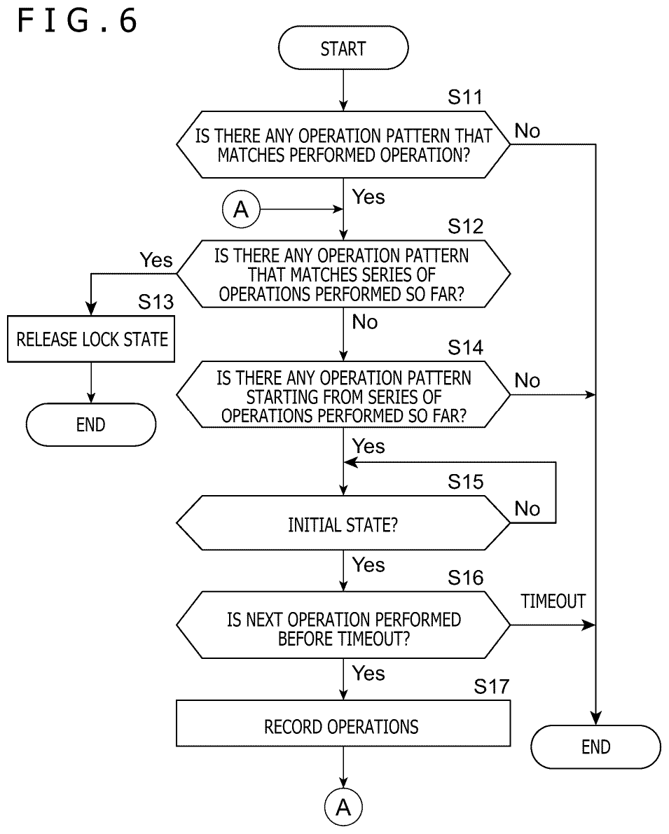

When receiving, from the output processing section 32, an input of information indicating an operation performed on the controller main body 11, the authentication processing section 33 according to the present embodiment starts an authentication process which is depicted in FIG. 6. In this process, the authentication processing section 33 determines whether or not there is an operation pattern defined for authentication, the operation pattern starting from the operation indicated by the inputted information (S11: Is there any matching operation pattern?).

When there is no operation pattern defined starting from the operation indicated by the inputted information, at step S11 (S11: No), the authentication processing section 33 exits the authentication process. When there is an operation pattern defined starting from the operation indicated by the inputted information, at step S11 (S11: Yes), the authentication processing section 33 checks whether or not there is an operation pattern defining a series of operations matching a series of operations inputted so far (S12). At step S12, the authentication processing section 33 searches for an operation pattern defining a series of operations Mi (i=1, 2 . . . , N) including N operations that completely matches with a series of operations Ii (i=1, 2 . . . , N) including N inputted operations (N is a natural number not smaller than 1).

When there is an operation pattern defining a series of operations matching a series of the operations inputted so far, at step S12 (S12: Yes), the authentication processing section 33 considers that the authentication is successful, and outputs a command to release the lock state, to the output processing section 32 (S13).

Meanwhile, when there is no operation pattern defining a series of operations matching a series of the operations inputted so far, at step S12, the authentication processing section 33 determines whether or not there is an operation pattern defining a series of operations starting from the operation pattern defining the series of operations matching a series of the operations inputted so far (S14).

At step S14, the authentication processing section 33 searches for an operation pattern defining a series of operations Mi (i=1, 2 . . . ) including N+1 or more operations and starting from the series of operations Ii (i=1, 2 . . . , N) including the N inputted operations (N is a natural number not smaller than 1) (that is, a forward matching operation pattern).

When determining that, at step S14, there is no operation pattern satisfying the above condition (S14: No), the authentication processing section 33 exits the authentication process. Meanwhile, when determining that, at step S14, there is an operation pattern satisfying the above condition (S14: Yes), the authentication processing section 33 waits for a predetermined initial state (e.g., a state of being held in a hand) (S15), and then, waits for an input of next information after the predetermined initial state is established (S16).

If the controller apparatus 10 is left (none of the electrostatic capacitance sensors 12 detects a pressing force, or detects approach of a finger or a hand) and then a predetermined timeout period elapses at step S16 (S16: timeout), the authentication processing section 33 exits the process. Meanwhile, if information other than information indicating the “left” state is inputted at step S16, the authentication processing section 33 checks whether or not an operation indicated by the inputted information is included in information regarding a list of predetermined operations to be ignored (referred to as operation information to be ignored). If the operation indicated by the inputted information here is included in the operation information to be ignored, the authentication processing section 33 continues the process of step S16. Meanwhile, if the operation indicated by the inputted information is not included in the operation information to be ignored, the authentication processing section 33 adds the information to a series of the inputted operations (S17), returns to step S12, and continues the processes.

It is to be noted that, for example, a list of operations that have to be performed before a user performs the next operation for authentication is used as the operation information to be ignored. In one example, when a user presses the controller main body 11 in the first axis direction and then presses the controller main body 11 to the second axis direction, a state where the user is touching the controller main body 11 is continued because, for example, the user moves a hand to adjust a pressing direction or to rotate the controller apparatus 10. Therefore, in this case, a “touching” operation is included in the operation information to be ignored. The operation information to be ignored may be determined in advance, or may be determined, on the basis of the next operation (the N+1-th operation in the above example) in the operation pattern found at step S14, as a list of at least some of operations excluding the next operation.

Further, in a case where all operations for authentication to be included in an operation pattern are limited to pressing operations (operations of pressing in one direction or operations of gripping), a list of operations excluding the pressing operations may be determined in advance as the operation information to be ignored here.

According to the authentication process at the authentication processing section 33, in a case where an operation pattern of a permutation of the following three operations, that is,
(Operation 1) pressing the controller main body 11 in any one of the axis directions (referred to as the first axis direction) and deforming the controller main body 11 into a flat state,
(Operation 2) pressing the controller main body 11 in an axis direction (referred to as the second axis direction) orthogonal to the first axis direction and deforming the controller main body 11 into a flat state, and
(Operation 3) pressing the controller main body 11 in an axis direction orthogonal to the second axis direction and deforming the controller main body 11 into a flat state,
is defined as an authentication operation, when the user presses the controller main body 11 of the controller apparatus 10 in any first axis direction and deforms the controller main body 11 into a flat state (Operation A), the authentication process is started. Since an operation pattern starting from the operation A has been defined (Yes at steps S11 and S14) and there is no operation pattern defined by only an operation the same as the operation A (step S12: No), the flow proceeds to step S14. Since the condition at step S14 is satisfied, as previously explained, the flow proceeds to step S15 at which an initial state (information indicating that the controller main body 11 is simply held in a hand is inputted from the output processing section 32) is waited for. After the initial state is established, the next operation is waited for (step S16).

Here, if the user performs an operation other than the operation 2 defined in the operation pattern, or performs, for example, an operation of pressing the controller main body 11 again in the first axis direction and deforming the controller main body 11 into a flat state, a series of the inputted operations, that is, an operation pattern starting from
(Operation A) pressing the controller main body 11 in the first axis direction and deforming the controller main body 11 into a flat state, and
(Operation B) pressing the controller main body 11 in the first axis direction and deforming the controller main body 11 into a flat state,
has not been defined at step S14 in the process performed again from step S12, so that it is considered that the authentication has failed, and the process is exited.

On the other hand, if the above operation A is followed by the operation 2 defined in the operation pattern, that is,
(Operation B′) pressing the controller main body 11 in an axis direction (referred to as the second axis direction) orthogonal to the first axis direction and deforming the controller main body 11 into a flat state,
the flow proceeds to step S14, and then, to step S15 at which an initial state is waited for, because an operation pattern starting from the operation A and the operation B′ has been defined. After the initial state is established, the next operation is waited for (step S16). Then, if
(Operation C) pressing the controller main body 11 in an axis direction orthogonal to the second axis direction and deforming the controller main body 11 into a flat state
is further performed, the authentication processing section 33 considers that the authentication is successful, because there is an operation pattern defining a series of operations matching a series of the operations (the operation A, the operation B′, and the operation C) inputted, in the process performed again from step S12. Then, the authentication processing section 33 outputs a command to release the lock state, to the output processing section 32 (step S13).

### [Operations]

The controller apparatus 10 according to the embodiment of the present invention basically has the above-mentioned configurations, and operations thereof are as follows. According to the present embodiment, the controller apparatus 10 performs control to set a lock state of the controller apparatus 10 itself when no operation is performed (the controller apparatus 10 is left) for a predetermined time period.

During the lock state, the controller apparatus 10 performs control to refrain from transmitting, to the information processing apparatus 20, information indicating an operation performed by a user.

The controller apparatus 10 accepts a series of user operations, checks whether or not the accepted series of operations matches any one of predetermined operation patterns defining series of operations for authentication, and considers that the authentication is successful and releases the lock state when the accepted series of operations matches any one of the operation patterns.

The controller apparatus 10 transmits information indicating an operation that is performed after the lock state is released, to the information processing apparatus 20.

### [Reporting State]

In addition, in the authentication process in which the control section 131 serves as the authentication processing section 33, the control section 131 may control the report section 134 to present at least one of light, sounds, or vibrations at step S17 depicted in FIG. 6, for example, such that a user is notified of acceptance of an operation (operation acceptance report).

Further, in this case, the authentication process may not immediately be exited even after it is determined that, at step S14, there is no operation pattern satisfying the condition. The authentication processing section 33 may issue an operation acceptance report by presenting at least one of light, sounds, or vibrations each time an operation that is not included in the operation information to be ignored is performed. Accordingly, a report indicating that the operation has been accepted is given to the user, and the user can understand that the operation has been accepted. Further, even after there is no more operation pattern satisfying the condition, an operation acceptance report in the same form is issued as long as an operation is accepted. Accordingly, it is possible to prevent leakage of the details of authentication operations that are defined as operation patterns.

Moreover, in the process at step S13 of the authentication process in which the control section 131 serves as the authentication processing section 33, to release a lock state, the control section 131 controls the report section 134 to present at least one of light, sounds, or vibrations to report release of the lock state. It is also preferable that a form of the report (a form of light, sounds, or vibrations) at this time be different from that of an operation acceptance report.

In any other cases, if reporting is required, the control section 131 may control the report section 134 to present at least one of light, sounds, or vibrations.

### [Reset Operation]

In addition, in the present embodiment, a reset operation (operation of halting the authentication process) of the authentication operation may be defined in advance. For example, an operation of “gripping the controller main body 11 for a predetermined reset operation time period or longer” or other operations may be determined in advance as the reset operation.

In this case, in the process at step S16 of the authentication process in which the control section 131 serves as the authentication processing section 33, the control section 131 determines whether or not a “gripping” operation is performed for the predetermined reset operation time period described above, and halts the authentication process when determining that the “gripping” operation is performed.

In this example, when a user determines that the user has performed a misoperation, the user can start over an operation again by continuing to grip the controller main body 11 for the reset operation time period. Also in this case, when halting the authentication operation, in order to report the halt of the authentication operation, the control section 131 may control the report section 134 to present at least one of light, sounds, or vibrations.

### [Operation for Setting Lock State]

In addition, when accepting a predetermined operation (or a predetermined series of operations) while a lock state is released, the control section 131 may set the controller apparatus 10 into a lock state.

In this example, as an operation for setting the lock state, an operation of, for example, pressing the controller main body 11 in the first axis direction and then pressing the controller main body 11 in the second axis direction orthogonal to the first axis direction (an operation pattern for determining a series of the operations will hereinafter be referred to as a lock operation pattern) is determined in advance.

When a series of the operations determined in the lock operation pattern is performed in order while the lock state is released, the control section 131 sets the controller apparatus 10 into a lock state.

### [Operation Pattern Setting]

In addition, it is also preferable that the operation pattern and the lock operation pattern can be set by a user as desired. In this example, an operation (setting start operation) for starting an authentication pattern may be determined in advance.

Therefore, an operation (operation pattern setting start operation) for starting operation pattern setting may be determined in advance.

When the operation pattern setting start operation (for example, an operation of gripping the controller main body 11 for a predetermined time period) is performed during an unlocked state, the control section 131 starts a process for accepting operation pattern setting. To report the start of this process, the control section 131 may control the report section 134 to present at least one of light, sounds, or vibrations.

After this process is started, each time a predetermined operation (hereinafter, referred to as an operation to be recorded) to be recorded is performed by a user and is detected, the control section 131 records information indicating the operation to be recorded. Operations to be recorded herein are operations excluding, from detectable operations, operations defined in the above-mentioned operation information to be ignored (for example, a “touching” operation) and an operation defined in advance as an operation indicating recording to be ended.

When an operation to be recorded is accepted a predetermined maximum number of times or a user performs an operation indicating recording to be ended, the control section 131 records, as an operation pattern, a permutation of information indicating operations recorded so far.

To allow lock operation pattern setting, the control section 131 operates in a similar way. In this case, it is sufficient if an operation for starting lock operation pattern setting is set to be different from the above-mentioned operation pattern setting start operation.

### Example of Additionally Using Deformation Quantity Information

Further, in the explanation given so far, when two electrostatic capacitance sensors in any one of the axis directions each detect a pressing force equal to or larger than a predetermined force, the control section 131 determines that the controller main body 11 is pressed in one direction and is deformed into a flat shape. Here, a deformation quantity of the shape may be additionally estimated from the magnitude of the pressing force, and the deformation quantity may be used in the process.

In this example, when detecting that the controller main body 11 is pressed, the detection processing section 31 additionally detects information regarding the pressing force.

Further, when an elastic deformation operation of, for example, gripping the controller main body 11 or pressing the controller main body 11 in a predetermined axis direction and deforming the controller main body 11 into a flat shape is included in an operation pattern, the authentication processing section 33 further uses a condition for a deformation quantity of the elastic deformation (specifically, the condition may be determined from a pressing force applied to the controller main body 11).

That is, in this example of the present embodiment, the above-mentioned operation pattern includes
(Operation 1) pressing the controller main body 11 in any one of the axis directions (referred to as the first axis direction) with a pressing force P1±ΔP and deforming the controller main body 11 into a flat state,
(Operation 2) pressing the controller main body 11 in an axis direction (referred to as the second axis direction) orthogonal to the first axis direction with a pressing force P2±ΔP and deforming the controller main body 11 into a flat state, and
(Operation 3) pressing the controller main body 11 in an axis direction orthogonal to the second axis direction with a pressing force P3±ΔP and deforming the controller main body 11 into a flat state,
for example. Thus, the operation pattern including pressing force conditions is set.

Then, at step S11 and step S16 in FIG. 6, when an inputted operation is an elastic deformation operation, the authentication processing section 33 further obtains the pressing force P from the output processing section 32, and determines not only the type of an operation (deforming into a flat shape, gripping, or the like) defined in the operation pattern, but also whether or not the pressing force condition is satisfied.

For example, in a case where, at step S11, an operation first performed by a user is an operation of pressing the controller main body 11 in the first axis direction and deforming the controller main body 11 into a flat state but the pressing force P does not fall within a range of the pressing force P1±ΔP (P<P1−ΔP or P>P1+ΔP) indicated by the operation 1 in the above operation pattern, the authentication processing section 33 determines that the operation mismatches with the above operation pattern.

Meanwhile, in a case where, at step S11, an operation first performed by the user is an operation of pressing the controller main body 11 in the first axis direction and deforming the controller main body 11 into a flat state and the pressing force P falls within the range of the pressing force P1±ΔP (P1−ΔP≤P≤P1+ΔP) indicated by the operation 1 in the above indicated by the operation 1 of the above operation pattern, the authentication processing section 33 determines that an operation pattern starting from the operation indicated by the inputted information has been defined.

### [Case of Defining Directions]

In the explanation given so far, it is assumed that up and down directions or left and right directions are not determined with respect to the controller main body 11 of the controller apparatus 10.

Therefore, in a case where directions can first be defined by an operation in an operation for authentication, the direction of the following operation is determined on the basis of the defined directions. For example, in a case where an operation pattern of pressing the controller main body 11 in the first axis direction and then pressing the controller main body 11 in a direction orthogonal to the first axis direction is defined as an operation for authentication, the direction of the pressing operation performed first is determined as the first axis direction.

However, the present embodiment is not limited to this case. For example, a projected part or a recessed part may be disposed in a position, on a surface of the controller main body 11, to be defined as an up direction, such that the up and down directions are indicated, and a direction of an axis connecting the electrostatic capacitance sensor 12 that is disposed in the position to be defined as the up direction and the electrostatic capacitance sensor 12 that is disposed in an opposed position to be defined as the down direction may be determined as the Z axis direction.

According to this example, the Z axis direction can be determined as the first axis direction, for example. Likewise, if, for example, electrostatic capacitance sensors 12 are arranged in six directions, that is, in the up and down directions (corresponding to a Z axis), the left and right directions (corresponding to an X axis), and front and rear directions (corresponding to a Y axis), with respect to the center of the controller main body 11, different signs may be put near the respective electrostatic capacitance sensors 12 of the controller main body 11 (for example, the signs are printed on the surface) to thereby define the axis directions. For example, a sign “o” is disposed near the electrostatic capacitance sensor 12 that is disposed in the up direction, a sign “×” is disposed near the electrostatic capacitance sensor 12 that is disposed in the down direction, and a sign “Δ” is disposed near the electrostatic capacitance sensor 12 that is disposed in the left direction . . . , and thus, the axis directions can be determined. Accordingly, the directions can be used by the control section 131 to determine the type of an operation.

### [Controlling Lock State of Information Processing Apparatus]

Further, in the explanation given so far, the controller apparatus 10 releases a lock state of the controller apparatus 10 itself according to a user operation. However, the embodiment of the present invention is not limited to this example.

That is, in a certain example of the present embodiment, when accepting a predetermined authentication operation, the controller apparatus 10 may release a lock state of the information processing apparatus 20 that is connected to the controller apparatus 10 in a communicable manner.

In this example, when the information processing apparatus 20 is in a lock state (in a state for accepting only limited operations including an authentication operation), for example, the information processing apparatus 20 receives a command to release the lock state, from the controller apparatus 10, and releases the lock state.

Further, in this example, while a lock state of the controller apparatus 10 is released, the controller apparatus 10 performs an authentication process for releasing a lock state of the information processing apparatus 20. This authentication process is similar to that depicted in FIG. 6. If, at step S12, there is an operation pattern defining a series of operations matching a series of inputted operations (an operation pattern determined as operations for releasing a lock state of the information processing apparatus 20), it is considered that the authentication is successful, and a command to release the lock state is transmitted to the information processing apparatus 20.

### [Recognition of Gestures]

In addition, the controller apparatus 10 according to the present embodiment may detect a user operation performed on the controller main body 11, and may estimate a pose of a user hand operating the controller apparatus, on the basis of the detected operation. Alternatively, the controller apparatus 10 may detect a user operation performed on the controller main body 11 and output information indicating the details of the operation to the information processing apparatus 20, and the information processing apparatus 20 may estimate a pose of a user hand operating the controller apparatus, on the basis of the detected operation.

In this example, the controller apparatus 10 or the information processing apparatus 20 determines in advance a relation between the type of an operation performed by a user (or a deformation quantity of the controller main body 11 when the operation is performed, that is, a pressing force applied by the user) and a pose of a user hand, or obtains in advance a machine learning model for estimating such a relation through machine learning.

Further, the controller apparatus 10 or the information processing apparatus 20 estimates a pose of the user hand on the basis of, for example, the type of a user operation detected by the controller apparatus 10, and uses information regarding the estimated hand pose, for control of an application program, for example, in the information processing apparatus 20 (control of a game character, for example).

### [Account Switching]

In addition, different login accounts of a plurality of users may be set in the information processing apparatus 20. In this case, through a predetermined operation on the controller apparatus 10, for example, a login account may be switched.

Specifically, when a user performs a series of operations including at least one predetermined operation or when a user makes a predetermined hand pose while the controller apparatus 10 is in a lock-released state, the controller apparatus 10 may give a command to switch a login account, to the information processing apparatus 20.

### [Other Sensors]

In the explanation of the present embodiment given so far, the electrostatic capacitance sensors are used as sensors for detecting a user operation. The present embodiment is, however, not limited to this example. Strain sensors or any other pressure sensitive sensors may be used as long as the sensors can detect pressing forces.

### REFERENCE SIGNS LIST

10: Controller apparatus
11: Controller main body
12: Electrostatic capacitance sensor
13: Circuit section
20: Information processing apparatus
31: Detection processing section
32: Output processing section
33: Authentication processing section
120: Base section
121: Electrode
122: Lead section
123: Wiring section
131: Control section
132: Storage section
133: Communication section
134: Report section
135: Power source section
136: Interface section

1. A controller apparatus that is connected to an information processing apparatus in a communicable manner, the controller apparatus comprising:
a main body that is elastically deformable;
a detection section that detects a user operation performed on the main body; and
an output section that outputs information indicating an operation detected by the detection section to the information processing apparatus, wherein
the information outputted by the output section is used in an authentication process of controlling a lock state of the controller apparatus or the information processing apparatus.

2. A controller apparatus that is connected to an information processing apparatus in a communicable manner, the controller apparatus comprising:
a main body that is elastically deformable;
a detection section that detects a user operation performed on the main body; and
an authentication section that determines whether or not an operation detected by the detection section is a predetermined authentication operation and that performs an authentication process, wherein,
in a case where the authentication section determines that the predetermined authentication operation has been performed, a lock state of the controller apparatus or the information processing apparatus is controlled.

3. The controller apparatus according to claim 1, wherein operations for use in the authentication process include an operation involving at least one type of elastic deformation of the main body detected by the detection section.

4. The controller apparatus according to claim 1, wherein
the predetermined authentication operation is a predetermined operation pattern including at least one type of an operation detected by the detection means, and
a plurality of operation patterns for the predetermined authentication operation are determined, and, in the authentication process, when a series of any operations among the plurality of determined operation patterns is performed, it is determined that the predetermined authentication operation has been performed, and a lock state of the controller apparatus or the information processing apparatus that is in the predetermined lock state is released.

5. The controller apparatus according to claim 1, further comprising:
a report section including at least one of a light emission section, a sound producing section, and a vibration section, wherein,
in a case where a predetermined operation is performed, the authentication section causes the report section to operate to perform at least one of a light emitting operation, a sound producing operation, or a vibrating operation.

6. The controller apparatus according to claim 5, wherein, when the detection section detects an authentication-related predetermined operation, the report section is caused to operate to perform at least one of the light emitting operation, the sound producing operation, or the vibrating operation.

7. An information processing system comprising:
a controller apparatus having a main body that is elastically deformable; and
an information processing apparatus that is connected to the controller apparatus in a communicable manner, wherein
the controller apparatus detects a user operation performed on the main body,
on a basis of the detected operation, at least one of the controller apparatus or the information processing apparatus estimates a pose of a user hand operating the controller apparatus, and
information regarding the estimated pose of the hand is used in a predetermined process.

8. A control method for a controller apparatus that has an elastically deformable main body and is connected to an information processing apparatus in a communicable manner, the control method comprising:
detecting a user operation performed on the main body;
determining whether or not the detected operation is a predetermined authentication operation; and
in a case where the predetermined authentication operation is determined to have been performed, controlling a lock state of the controller apparatus or the information processing apparatus.

9. A non-transitory, computer readable storage medium containing a program, which when executed by one or a plurality of processors to control an information processing apparatus or a controller apparatus that is connected to the information processing apparatus in a communicable manner and has an elastically deformable main body, the program causing the one or plurality of processors to execute actions, comprising:
detecting a user operation performed on the main body;
determining whether or not the detected operation is a predetermined authentication operation; and
in a case where it is determined that the predetermined authentication operation has been performed, controlling a lock state of the controller apparatus or the information processing apparatus.
